(19) United States
(12) Patent Application Publication
(10) Pub. No.: US 2013/0330638 A1
(43) Pub. Date: Dec. 12, 2013

(54) COATED SUBSTRATE AND PRODUCT INCLUDING THE SAME AND METHODS OF MAKING AND USING THE SAME

(71) Applicants: GAYATRI VYAS DADHEECH, BLOOMFIELD HILLS, MI (US); MARK W. VERBRUGGE, TROY, MI (US)

(72) Inventors: GAYATRI VYAS DADHEECH, BLOOMFIELD HILLS, MI (US); MARK W. VERBRUGGE, TROY, MI (US)

(73) Assignee: GM GLOBAL TECHNOLOGY OPERATIONS LLC, DETROIT, MI (US)

(21) Appl. No.: 13/494,609

(22) Filed: Jun. 12, 2012

(51) Int. Cl. H01M 8/00; B05D 5/12

(52) U.S. Cl. 429/400; 427/115

(57) ABSTRACT

One embodiment may include a product including a substrate and a stress spring over the substrate. The stress spring may be constructed and arranged over the substrate so that the stress spring prevents or limits damage or undesirable effects caused by subsequent operations performed on the substrate or upon subsequent exposure of the substrate to high strain conditions. The stress spring may include a layer including an alloy or polymer.

### TECHNICAL FIELD

The field to which the disclosure generally relates includes coated substrates, products including coated substrates and methods of making and using the same.

### BACKGROUND

Coatings may be formed on a substrate to protect the substrate or to provide desirable properties or functions.

### SUMMARY OF ILLUSTRATIVE EMBODIMENTS

One embodiment of the invention may include a method including providing a substrate, the substrate having a first face, a laminate attached to the substrate, the laminate including a stress spring including a first layer over the first face of the substrate and a second layer over the first layer, the second layer being connected to the first layer and the substrate, and forming features in the first face of the substrate and so that the stress spring changes shape during the forming features so that the second layer does not crack or does not become disconnected from the first layer or the substrate.

Another embodiment may include a product including a substrate comprising a first face having features formed therein, a stress spring over the first face of the substrate comprising at least one of a shape memory alloy, shape memory polymer, a superelastic alloy, superelastic polymer, or superelastic carbon nano tubes, and a second layer over the stress spring.

A method comprising forming at least one of a superplastic alloy, superplastic polymer shape memory alloy or shape memory alloy layer over a substrate and forming features in the substrate.

Another embodiment may include a method comprising coating a substrate with a first layer comprising nickel and titanium, coating the first layer with a second layer comprising graphitic carbon, stamping the substrate having the first layer and second layer thereon to form a fuel cell reactant gas flow field having a plurality of lands segments and channel segments in a first face of the substrate, and wherein the second layer is free of cracks.

Other exemplary embodiments of the present invention will become apparent from the detailed description provided hereinafter. It should be understood that the detailed description and specific examples, while indicating the exemplary embodiment of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings.

FIG. 1 illustrates a product including a fuel cell bipolar plate having first and second faces each having a stress spring over a first face of the bipolar plate, and a graphitic/conductive carbon film deposited thereon, according to one illustrative embodiment of the invention.

FIG. 2 illustrates a product including a fuel cell bipolar plate having first and second faces each having a stress spring over a first face of the bipolar plate, and a graphitic/conductive carbon film deposited thereon, according to one illustrate embodiment of the invention.

FIG. 3 is a graph illustrating comparative tests performed for fuel cells including bipolar plates made from stainless steel substrates coated with a first (interlayer) and a second layer including graphitic carbon make according to one embodiment of the invention compared to gold plated bipolar plates.

### DETAILED DESCRIPTION OF EXEMPLARY EMBODIMENTS

The following description of the embodiment(s) is merely exemplary in nature and is in no way intended to limit the invention, its application, or uses.

One embodiment may include a product including a substrate and a stress spring over the substrate. The stress spring may be constructed and arranged over the substrate so that the stress spring prevents or limits damage or undesirable effects caused by subsequent operations performed on the substrate or upon subsequent exposure of the substrate to high strain conditions. A substrate with a stress spring there over may be utilized in a variety of applications. Non-limiting examples of such applications are described herein and are provided for illustrative purposes only and are not intended to limit the scope of the invention in any way.

In one embodiment the stress spring may include a first layer of at least one of an alloy or polymer. In one embodiment the first layer including at least one of a shape memory alloy, a superelastic alloy, a shape memory polymer or a superelastic polymer. Shape memory alloys or shape memory polymers may include materials that can be deformed upon exposure to an external stimuli including, but not limited to, heat, and after removing the external stimuli, the shape memory alloy or shape memory polymer returns to its original or near original shape. That is, the alloy or polymers appear to have a memory of their original shape. Shape memory alloys or shape memory polymers may have superelastic properties and are sometimes referred to as superelastic alloys or superelastic polymers. Typically shape memory alloys and shape memory polymers display superelasticity when the alloys or polymers are strained.

Superelastic alloys possess the ability to reversibly change shape at large strains compared to conventional metallic alloys upon the application and relaxation of an applied stress. These superelastic alloys can accommodate such large and reversible strains due to a reversible, self-induced phase transformations. These phase transformations typically involve, but are not limited to, the phases: austenite and martensite, with austenite being stable in the low stress state and martensite in the high stress state. Because the phase transformations are stress assisted, the overall stress-strain response is non-linear and discontinuous. At low stresses, the austenite remains stable and obeys the linear elastic (Hookean) behavior until a critical stress is reached, above which, the austenite phase begins to transform to martensite. Upon further deformation, the superelastic alloy continues to transform to martensite and deforms at a constant stress until all the austenite has been fully transformed. Once the phase transformation has been completed, stress increases again with strain until material yields plastically.

The region of constant stress is known as the plateau stress, and corresponds to the beginning and end of the phase transformation. Theoretically, the degree of phase transformation is proportional to the fractional position of strain so that 0% transformation exists at one end of the stress plateau, and 100% transformation at the other. It is this stress plateau that provides the most significant strain in the elastic-super-elastic stress/strain response, and is responsible for the majority of the reversible transformation strain and, thus, for the recoverable transformation strain back to the materials prescribed shape at low stress.

In one embodiment of the invention superelastic alloys can be utilized as a non-linear stress springs to facilitate forming of a bipolar plate. When the plate material is deformed in the room-temperature (or elevated temperature) stamping process, the superelastic material stretches and remains continuous much more so; than conventional metal, and adherent, high-quality coatings can be produced.

Superelastic polymers may be thermoplastic elastomers based on novel molecular architectures. They are characterized by very high elongation at break (e.g., partly more than 1500%) with simultaneously very low residual strains. Certain carbon nanotubes may be superelastic and may be used as the stress spring.

In one embodiment the stress spring may be electrically conductive. Illustrative examples of suitable materials for the stress spring include, but are not limited to, alloys including nickel and titanium, alloys including NiTi, or alloys with nickel and titanium and one or more additional elements including, if not limited to, NiTiFe or NiTiNb. Such alloys may also be doped with a number of materials. Illustrative examples of doping materials include, but are not limited to, iron, copper, hydrogen, phosphorus, potassium, titanium dioxide may be used to dope NiTi alloys. Other suitable materials for the stress spring include, but are not limited to, ferrous polycrystalline shape memory alloys, AuCd alloys, CuZnAl, CuAlNi, NiMnGa, or CuZnAl.

In one embodiment, the stress spring may include an alloy including nickel and titanium wherein the weight ratio of nickel to titanium ranges from about 20:80 to about 80:20. In one embodiment, the stress spring may include an alloy including nickel and titanium wherein the weight ratio of nickel to titanium ranges from about 40:60 to about 60:40. In one embodiment, the stress spring may include an alloy including nickel and titanium wherein the weight ratio of nickel to titanium ranges from about 60:40 to about 50:50. NiTi layers are also corrosive resistant and could be used in fuel cells without affecting other components in the fuel cell. NiTi materials also have good impact resistance and high fatigue strength.

In one embodiment, a second layer may be provided over the first layer. The second layer may include any of a variety of materials which may be adversely affected by subsequent operations performed on the substrate including, but not limited to, forming the substrate into another shape or forming features in at least one face of the substrate. In one embodiment the second layer may include a graphitic material. In one embodiment the stress spring may include graphitic carbon. In one embodiment the graphite carbon may have more sp2 bonding than sp3 bonding.

In one embodiment, one or more layers may be interposed between the substrate and the stress spring. In another embodiment, one or more layers may be interposed between the stress spring and the second layer. In one embodiment, one or more of a seed layer, adhesion improvement layer or a current shunting layer may be interposed between the substrate and the stress spring or the stress spring and the second layer. In select embodiment, one or more layers including at least one of Ti, Cr, NiCr, Al, TiN or Cu may be interposed between the substrate and the stress spring or interposed between the stress spring and the second layer.

In one embodiment, a product including substrate with a stress spring over the substrate may undergo a variety of processing operations including, but not limited to, forming or bending the substrate into another shape or forming features in a first face of the substrate. The stress spring may be utilized to prevent damage to the substrate or any other coatings or layers which may be interposed between the stress spring and the substrate or which may overlie the stress spring. In another embodiment, a product including a substrate with a stress spring over the substrate may be subjected to high strain or elongation caused by, for example, impact or stretching of the substrate.

One embodiment may include a method of making a fuel cell bipolar plate including providing a substrate having a first face and a second face. A stress spring may be provided over the first face of the substrate, for example, by forming or depositing a layer including a shape memory polymer, shape memory alloy, superelastic alloy, superelastic polymer or a layer of superelastic carbon nano tubes. In one embodiment, a stress spring may be provided over the first face of the substrate by depositing a layer including nickel and titanium, for example, but not limited to, NiTi. The layer including nickel and titanium may be deposited or formed to a variety of thicknesses. In one embodiment, the thickness of the layer including nickel and titanium may range from about 1 nm to about 500 nm. In another embodiment the thickness of the layer including nickel and titanium may range from about 1 nm to about 50 nm.

A second layer may be provided over the first layer including the nickel and titanium to provide, for example, protection of the substrate from corrosive materials produced by the operation of the fuel cell. In one embodiment, the second layer may include a graphitic material. In one embodiment, the second layer may include graphitic carbon having more sp2 bonding than sp3 bonding.

In one embodiment, features may be formed in the first face of the substrate including stamping the substrate having the stress spring over a first face of the substrate and a second coating over the stress spring so that the stress spring prevents damage to the second layer during the stamping. It has been discovered that the use of a stress spring interposed between a second layer including, for example, graphitic carbon over the stress spring prevents the second layer from cracking, peeling, delaminating or disconnecting from this stress spring or the substrate. The second layer including graphitic carbon may be constructed and arranged to protect the substrate from corrosive materials produced during the operation of the fuel cell and/or to provide other desirable properties or functions. If the second layer becomes cracked, peels, de-laminates or separates from the substrate, corrosive materials can reach the substrate and damage the same. Furthermore, if the second layer becomes cracked, peels, de-laminates or separates from the substrate, such may create voids where water may collect and may freeze during shutdown of the fuel cell.

In one embodiment, features may be formed on a first face of the substrate, such as, features defining a reactant gas flow field including a plurality of spaced apart lands segments and a plurality of spaced apart channel segments through which fuel cell reactant gas may flow. The features may be formed by any of a variety of processes including, but not limited to, stamping, vacuum drawing, hydroforming, or super plastic quick forming.

In one embodiment, the substrate may include any of a variety of materials known to those skilled in the art including, but not limited to, stainless steel, aluminum, titanium, or polymeric composite materials,

In one embodiment, the stress spring material they be deposited on the substrate in any of a variety of methods including, but not limited to, known to those skilled in the art now or in the future. Examples of such methods include, but are not limited to sputtering (e.g., magnetron, unbalanced magnetron, etc), chemical vapor deposition (“CVD”) (e.g., low pressure CVD, atmospheric CVD, plasma enhanced CVD, laser assisted CVD, etc), evaporation (thermal, e-beam, arc evaporation, etc.) and the like.

One embodiment may include a method of forming a fuel cell bipolar plate including a reactant gas flow field formed in a first face of a substrate, with a stress spring including a first layer interposed between the substrate and a second layer including graphitic carbon. In one embodiment the substrate may be provided in the form of a coil. The substrate may have a variety of thicknesses. In one embodiment the thickness of the substrate in a range from 50 micrometers to 200 micrometers. In one embodiment, the substrate may include stainless steel coil. The coil stainless steel may be unrolled and treated, for example, but not limited to, decreasing the surface of the substrate and removing oxides and other impurities. The pretreated coil stainless steel may be inspected to determine if the surface is in proper conditioned to deposit a stress spring material such as TiNi or if further pretreatment is required. The stainless steel substrate may be delivered to a coating station, for example, but not limited to, electron beam evaporation coating station where in a first face of the stainless steel substrate is exposed to a vapor including nickel and titanium produced from a target or targets and so that TiNi deposits on a first face of the stainless steel substrate. In one embodiment, the stainless steel substrate is shielded so that a second face of the stainless steel substrate is not exposed to the vapor from the electron beam process. Thereafter, the stainless steel substrate having a layer including TiNi on the first face of the substrate may be moved to a second coating station (which may be the same as the first coating station) wherein a layer of graphitic carbon may be deposited over the layer including TiNi using electron beam vaporization of graphite targets. Again, stainless steel substrate having the first layer including TiNi may be shielded so that graphitic carbon does not deposit on the second face of the stainless steel substrate. In one embodiment, a first portion of the stainless steel coil may be coated with the first layer including TiNi and thereafter the first portion of the stainless steel coil having the first layer including TiNi may be coated with the graphitic carbon. Thereafter, the stainless steel coil may be advanced so that a second portion may be coated in the same manner.

In another embodiment, stainless steel coil may be advanced through a coating station to deposit a first layer including TiNi on a first face of the stainless steel substrate and then the stainless steel coil may be sent back through the coating station with a second face of the stainless steel substrate exposed to targets including nickel and titanium so that the second face of the stainless steel substrate is coated with a second layer of TiNi. Thereafter, the coating process may be repeated but so that the second layer including graphitic carbon is deposited on the first layer including TiNi on the first face of the substrate and then the stainless steel coil is sent back through the coating station so that the second face including the second layer of TiNi is exposed to carbon targets and so that graphitic carbon is deposited over the second layer of TiNi over the second face of the stainless steel substrate.

The term “graphitic film” as used herein means a film that includes, resembles, or is derived from graphite. The graphitic film may be produced by sputtering graphite targets or other material described herein. The graphite film may include non-crystalline electrically conductive carbon. In one embodiment of the invention, the graphite film is amorphous and wherein Raman spectroscopy of the film indicates the presence of more sp² carbon bonding than sp³.

In another embodiment of the invention, graphite targets may be sputtered in a chamber under the influence of a closed field unbalanced magnetron field. The two graphite targets may be placed on strong magnetrons that may be sputtered at a current ranging from 5 A-10 A in a closed field magnetron arrangement. The pressure in the sputter chamber may range from 1×10⁻⁶ to 1×10⁻² Torr, a bias voltage of −400V to −20V, pulse width of 250 nanosecond to 2000 nanosecond, and pulse DC at frequency rate of 400 KHz to 50 KHz, and argon flow rate of 200 sccm to 20 sccm for a time period of 10 minutes to 500 minutes. The film may be deposited in a thickness ranging from 5 nm to 1000 nm, or 10 nm to 50 nm. Measurements conducted on bipolar plates including the graphitic/conductive carbon film indicated that the graphitic/conductive carbon film had a low contact resistance.

In another embodiment, sputtering chamber may include at least two gases, such as, but not limited to, argon and H₂. The flow rate of Ar may range from 20 to 150 sccm and H2 gas flow from 5 to 100 sccm. For example, in one embodiment two gases, Ar+H₂, may be used with a flow rate in range of 30 sccm, wherein Ar flow may be kept at 20 sccm and H2 flow was kept at 10 sccm. Films produce using a two gas method had improved electrical conductivity.

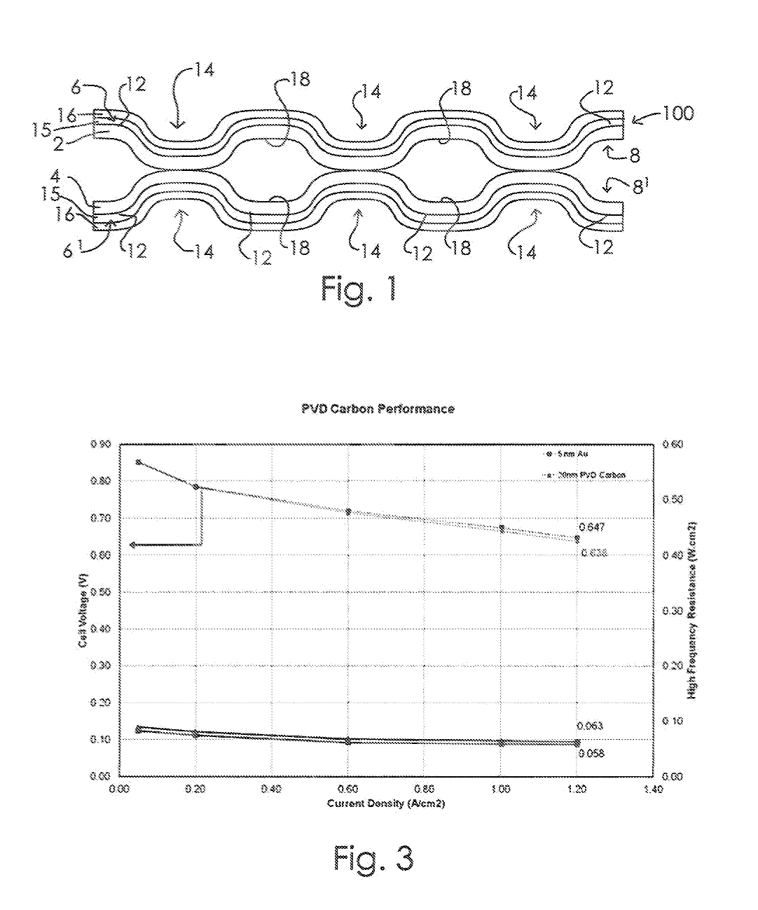

Referring now to FIG. 1, another embodiment of the invention includes a bipolar plate including a first thin metal sheet 2 and a second thin metal sheet 4 which each have been stamped or formed to provide a plurality of lands 12 and channels 14 in first and second faces 6, 6¹ respectively. Cooling channels 18 may be provided in second faces 8, 8¹ respectively, of the first metal sheet 2 and the second metal sheet 4. The stress spring including a first layer 15 may be formed or deposited over entire surface of the first faces 6, 6¹ or may be selectively deposited over portions of the first faces 6, 6¹. A second layer such as a graphitic/conductive carbon film 16 may be deposited over the entire surface of the first layer 15 or may be selectively deposited over portions of the first layer 15. For example, the graphitic/conductive carbon film 16 may be selectively deposited only on the lands 12 of the first metal sheet 2 and the second metal sheet 4.

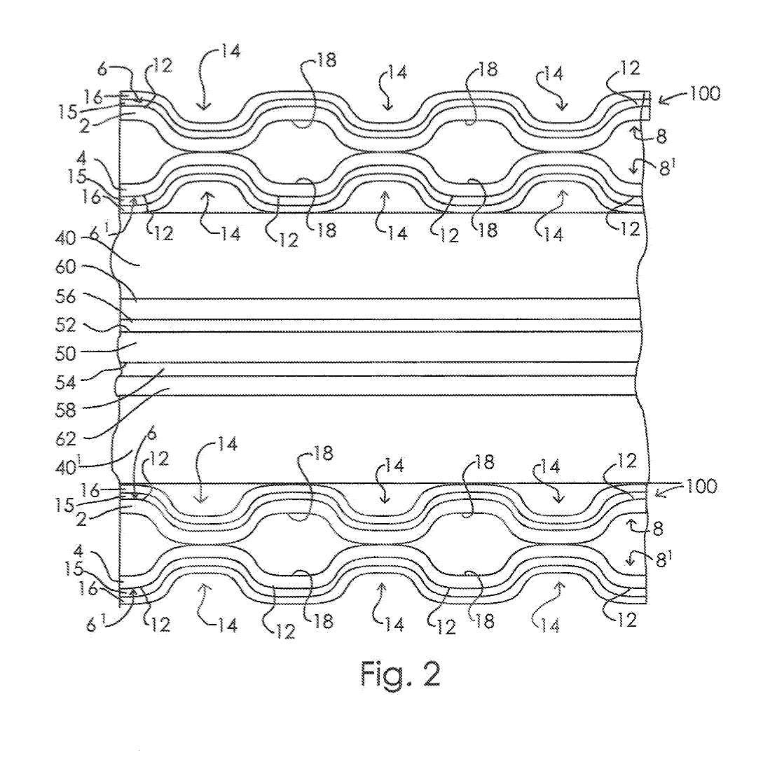

Referring now to FIG. 2, another embodiment of the invention includes a product 100 including a solid polymer electrolyte membrane 50 having a first face 52 and an opposite second face 54. An anode 56 may be provided over the first face 52 of the solid polymer electrolyte membrane 50. A first gas diffusion media layer 40 may be provided over the anode 56, and optionally a first microporous layer 60 may be interposed between the first gas diffusion media layer 40 and the anode 56. A first bipolar plate 10 having a plurality of lands 12 and channels 14 formed in a first face thereof may be provided over the first gas diffusion media layer 40. A graphitic/conductive carbon film 16 is interposed between the first gas diffusion media layer 40 and the first face 6 of the first bipolar plate 10. The graphitic/conductive carbon film 16 may cover the entire first face 42 of the gas diffusion media layer 40 or the graphitic/conductive carbon film 16 may cover the entire first face 6 of the bipolar plate. Optionally, the graphitic/conductive carbon film may be selectively deposited on portions of the first face 6 of the bipolar plate 10 or selectively deposited on portions of the first face 42 of the gas diffusion media layer 40. A cathode 58 may underline the second face 54 of the solid polymer electrolyte membrane 50. A second gas diffusion media layer 40¹ may underline the cathode layer 58, and optionally a second microporous layer 62 may be interposed between the second gas diffusion media layer 40′ and the cathode 58. A second bipolar plate 10¹ is provided and includes a plurality of lands 12¹ and channels 14¹ formed in a first face 6¹ thereof. A second graphitic/conductive carbon film 16¹ may be interposed between the first face 6¹ of the second bipolar plate 10¹ and the second gas diffusion media layer 40¹. The second graphitic/conductive carbon film may be sputtered onto the first face 42¹ of the second gas diffusion media layer 40¹ or on the first face 6¹ of the second bipolar plate 10′. A stress spring layer 15 may be interposed between the substrate 2, 4 and the second layer 6, 6′, respectively.

In another embodiment, after the graphitic/conductive carbon coatings are deposited, the coatings may be post treated by a post-treatment process to introduce polar functional moieties, (predominantly hydroxyl groups, amine and sulfur polar groups) onto the base graphitic/conductive carbon structure, thereby enhancing the material hydrophilicity.

In one embodiment of the invention, the post treatment may be done by exposing the graphitic/conductive carbon films to a reactive oxygen plasma which would activate the graphitic/conductive carbon coatings by breaking bonds and forming hydroxyl, carboxyl and aldehyde functional groups. This activation by post-treatment also enhances the material porosity, which may further enhance the material hydrophilicity.

In one embodiment of the invention, the post treatment may be done by exposing the graphitic/conductive carbon coating films to a reactive gases, such as, nitrogen, nitrous oxide, nitrogen dioxide, ammonia or mixture thereof which would activate the graphitic/conductive carbon coatings coating by breaking bonds and forming nitrogen based derivates like amines, amide, diazo functional groups. This activation by post-treatment also enhances the material porosity, which may further enhance the material hydrophilicity.

In one embodiment of the invention, the post-treatment may done by exposing the graphitic/conductive carbon coating films to a reactive sulfur based gas like hydrogen sulfide, thereof which would activate the graphitic/conductive carbon coatings by breaking bonds and forming sulfur based derivates like sulfates, sulphites and thiols functional groups. This activation by post-treatment also enhances the material porosity, which may further enhance the material hydrophilicity.

In another embodiment, the coating may be reacted with a chemical to produce the polar groups. In another embodiment, the polar groups may be introduced by. applying a thin layer of a hydrophilic coating.

In one embodiment of the invention, the post-treatment process may involve exposure to a pulsed DC reactive plasma environment for 0 to 10 minutes, preferably: 0.5 to 3 minutes, and most preferably: 2 minutes.

Referring now to FIG. 3, fuel cells including bipolar plates made from stainless steel substrates coated with a first layer (interlayer) and a second layer including graphitic carbon when tested showed similar cell voltage degradation and high frequency resistance (HFR) performance compared to gold plated bipolar plates.

The following numbered embodiments illustrative in nature of the scope of the invention and are not intended to limit the invention in any way.

Embodiment 1 may include a method including providing a substrate, the substrate having a first face, a laminate attached to the substrate, the laminate including a stress spring including a first layer over the first face of the substrate, and a second layer over the first layer, the second layer being connected to the first layer and the substrate, and forming features in the first face of the substrate so that the stress spring changes shape during the forming features so that the second layer does not crack or does not become disconnected from the first layer or the substrate.

Embodiment 2 may include a method as set forth in embodiment 1 wherein first layer has superelastic properties.

Embodiment 3 may include a method as set forth in any of embodiments 1-2 wherein the first layer comprises at least one of a superelastic alloy or superelastic polymer.

Embodiment 4 may include a method as set forth in any of embodiments 1-3 wherein the first layer comprises at least one of a shape memory alloy or a shape memory polymer.

Embodiment 5 may include a method as set forth in any of embodiments 1-4 wherein the first layer comprises an alloy comprising nickel and titanium.

Embodiment 6 may include a method as set forth in any of embodiments 1-5 wherein the first layer comprises TiNi.

Embodiment 7 may include a method as set forth in any of embodiments 1-6 wherein the weight ratio of Ni to Ti ranges from 20:80 to 80:20.

Embodiment 8 may include a method as set forth in any of embodiments 1-7 method as set forth in claim 1 wherein the second layer comprises graphitic carbon.

Embodiment 9 may include a method as set forth in any of embodiments 1-8 wherein the graphitic carbon includes more sp2 bonding than sp3 bonding.

Embodiment 1.0 may include a method as set forth in any of embodiments 1-9 wherein the forming features is conductive to produce a fuel cell reactant gas flow field in the first face of the substrate including a plurality of lands segments and a plurality of channel segments.

Embodiment 11 may include a method as set forth in any of embodiments 1-10 wherein the forming features comprises at least one of stamping, hydroforming, electromagnetic forming, pulse-pressure forming or superplastic forming of the substrate.

Embodiment 12 may include a method comprising forming at least one of a superplastic alloy, superplastic polymer shape memory alloy or shape memory alloy layer over a substrate and forming features in the substrate.

Embodiment 13 may include a product comprising a substrate comprising a first face having features formed therein, a stress spring over the first face of the substrate comprising at least one of a shape memory alloy, shape memory polymer, a superelastic alloy, superelastic polymer, or superelastic carbon nano tubes, and a second layer over the stress spring,

Embodiment 14 may include a method or product as set forth in any of embodiments 1-13 wherein the second layer is electrically conductive.

Embodiment 15 may include a method or product as set forth in any of embodiments 1-13 wherein the second layer comprises graphitic carbon.

Embodiment 16 may include a method or product as set forth in any of embodiments 1-14 wherein the first layer comprises nickel and titanium.

Embodiment 17 may include a method or product as set forth in any of embodiments 1-16 wherein the weight ratio of nickel to titanium ranges from about 20:80 to about 80:20.

Embodiment 18 may include a method or product as set forth in any of embodiments 1-17 wherein the thickness of the first layer ranges from 1 nm to 50 nm.

Embodiment 19 may include a method comprising coating a substrate with a first layer comprising nickel and titanium, coating the first layer with a second layer comprising graphitic carbon, stamping the substrate having the first layer and second layer thereon to form a fuel cell reactant gas flow field having a plurality of lands segments and channel segments in a first face of the substrate, and wherein the second layer is free of cracks.

Embodiment 20 may include a method or product as set forth in any of embodiments 1-19 wherein the weight ratio of nickel to titanium ranges from about 20:80 to about 80:20.

When the terms “over”, “overlying”, “overlies”, or “under”, “underlying”, “underlies” are used with respect to the relative position of a first component or layer with respect to a second component or layer, such shall mean that the first component or layer is in direct contact with the second component or layer, or that additional layers or components are interposed between the first component or layer and the second component or layer. Element and components described herein may be combined in a variety of combinations and the scope of the invention is not limited to specific combinations literally set forth herein.

The above description of embodiments of the invention is merely exemplary in nature and, thus, variations thereof are not to be regarded as a departure from the spirit and scope of the invention.

What is claimed is:

1. A method including providing a substrate, the substrate having a first face, a laminate attached to the substrate, the laminate including a stress spring including a first layer over the first face of the substrate, and a second layer over the first layer, the second layer being connected to the first layer and the substrate, and forming features in the first face of the substrate so that the stress spring changes shape during the forming features so that the second layer does not crack or does not become disconnected from the first layer or the substrate.

2. A method as set forth in claim 1 wherein first layer has superelastic properties.

3. A method as set forth in claim 1 wherein the first layer comprises at least one of a superelastic alloy or superelastic polymer.

4. A method as set forth in claim 1 wherein the first layer comprises at least one of a shape memory alloy or a shape memory polymer.

5. A method as set forth in claim 1 wherein the first layer comprises an alloy comprising nickel and titanium.

6. A method as set forth in claim 1 wherein the first layer comprises TiNi.

7. A method as set forth in claim 6 wherein the weight ratio of Ni to Ti ranges from 20:80 to 80:20.

8. A method as set forth in claim 1 wherein the second layer comprises graphitic carbon.

9. A method as set forth in claim 8 wherein the graphitic carbon includes more sp2 bonding than sp3 bonding.

10. A method as set forth in claim 1 wherein the forming features is conductive to produce a fuel cell reactant gas flow field in the first face of the substrate including a plurality of lands segments and a plurality of channel segments.

11. A method as set forth in claim 1 wherein the forming features comprises at least one of stamping, hydroforming, electromagnetic forming, pulse-pressure forming or superplastic forming of the substrate.

12. A method comprising forming at least one of a superplastic alloy, superplastic polymer shape memory alloy or shape memory alloy layer over a substrate and forming features in the substrate.

13. A product comprising a substrate comprising a first face having features formed therein, a stress spring over the first face of the substrate comprising at least one of a shape memory alloy, shape memory polymer, a superelastic alloy, superelastic polymer, or superelastic carbon nano tubes, and a second layer over the stress spring.

14. A product as set forth in claim 13 wherein the second layer is electrically conductive.

15. A product as set forth in claim 13 wherein the second layer comprises graphitic carbon.

16. A product as set forth in claim 15 wherein the first layer comprises nickel and titanium.

17. A product as set forth in claim 16 wherein the weight ratio of nickel to titanium ranges from about 20:80 to about 80:20.

18. A product as set forth in claim 17 wherein the thickness of the first layer ranges from 1 nm to 500 nm preferably in 1 nm to 50 nm.

19. A method comprising coating a substrate with a first layer comprising nickel and titanium, coating the first layer with a second layer comprising graphitic carbon, stamping the substrate having the first layer and second layer thereon to form a fuel cell reactant gas flow field having a plurality of lands segments and channel segments in a first face of the substrate, and wherein the second layer is free of cracks.

20. A method as set forth in claim 19 wherein the weight ratio of nickel to titanium ranges from about 20:80 to about 80:20.
